(19) United States
(12) Patent Application Publication
(10) Pub. No.: US 2007/0180719 A1
(43) Pub. Date: Aug. 9, 2007

(54) Electronic Level Indicator for Recreational Vehicles and Other Mobile Platforms

(75) Inventors: Edward J. Donnelly, Allison Park, PA (US); Ronald Cyprowski, Verona, PA (US)

Correspondence Address: BLYNN L. SHIDELER;THE BLK LAW GROUP, 3500 BROKKTREE ROAD, SUITE 200, WEXFORD, PA, 15090, US

(73) Assignee: RV INSITE, INC., Pittsburgh, PA (US)

(21) Appl. No.: 11/673,135

(22) Filed: Feb. 9, 2007

Related U.S. Application Data
(60) Provisional application No. 60/771,748, filed on Feb. 9, 2006.

(51) Int. Cl. G01C 9/06

(52) U.S. Cl. 33/366.11

(57) ABSTRACT

An accurate, easy-to-use, low cost level indication system can be easily installed on the exterior or interior of an RV. The device provides a visible and/or audible level indication that can be viewed from within the cab of the tow vehicle or motor home day or night. The device provides level indication along the 2 main RV axis's (side to side and front to back). The device can be calibrated at any time by the operator. Calibration can be performed on uneven terrain. The device can also store arrival inclination information for later recall during departure preparations.

### RELATED APPLICATIONS

This application claims the benefit of provisional U.S. patent application Ser. No. 60/771,748 entitled “Electronic Level Indicator for Recreational Vehicles and Other Mobile Platforms” and filed Feb. 9, 2006.

### BACKGROUND OF THE INVENTION

Operators of recreational vehicles (RV's) such as travel trailers, fifth wheel travel trailers, fold down campers, motor homes, and truck campers (a representative variety of which are shown in FIG. 1) are routinely faced with the task of leveling the RV at destinations, such as campground grounds or back country locations. Often, the desired parking location is not level in the S/S and or F/B orientation. Since RV's typically include sleeping and living quarters (cooking, dining and living room etc.), the proper leveling of the RV is important to the comfort and enjoyment of the occupants.

Once the RV is positioned in the desired location, the operator normally performs a leveling procedure that typically consists of first determining the S/S height difference of the RV. The RV can then be moved into a new position that compensates for the difference. A more common technique is to place graduated leveling blocks (wood or other material) in front of, or behind the tires of low side of the RV. The operator must then move the RV onto the graduated leveling blocks until the RV is level S/S. This requires a trial and error sequence of moving the RV small distances and rechecking the S/S level status. Checking the level status normally requires the operator to exit the tow vehicle or motor home cab, and monitor a bubble type level indicator mounted to the exterior of the RV. This procedure is further complicated during night time setup operations when the level bubble is not visible without an external light source. Often, manufactures do not apply any level indicators to the RV exterior or interior. In these cases the operator must use a carpenter's level or other means such as look and feel, or placing a glass of water at multiple locations within the RV to determine level status.

Once the S/S is leveled, the F/B inclination of the RV must be leveled. In the case of motor homes or truck campers, this operation must be performed in conjunction with the S/S leveling operation. Travel trailers are normally separated from the tow vehicle prior to F/B leveling. The F/B leveling procedure typically involves the raising or lowering the front jack of the trailer until level is achieved. The same type of level indicator device or procedure is employed as with S/S leveling (bubble level, look and feel etc.). This procedure also affords the same problems and drawbacks as the S/S level procedure.

Departure preparations for travel trailer type RV's require that the original F/B inclination angle of the trailer be restored in order to match the tow vehicle hitch system. This procedure usually requires a trial and error sequence of raising or lowering the trailer until the trailer hitch properly mates with the tow vehicle hitch receiver. Often, this activity must also be performed at night with limited visibility.

Level indicators that are currently commercially available on the market for RV use, are single axis, liquid filled devices that consist of an arced clear tube that contains an air bubble or other ball indicator, such as shown in FIG. 2. The mounting plates of these devices often contain graduated scales that indicate elevation increments usually in inches. Most level indicators of this type are relatively small and are not readable from within the tow vehicle. A large variation of the bubble level type devices are available on the market, but they are generally unsightly, prone to leakage, and not visible at night. Another issue with currently available commercial level indicators is that a separate device is needed for each axis of the RV (S/S and F/B). Because of the distances being measured, the scaling factor on the F/B indicator is different from the S/S level indicator, thus each axis must use a unique indicator. In addition, the F/B bubble level must accommodate RVs that range from 10 to 40 feet in length. This means there will be an inherent error with the scaling of the “one size fits all” F/B bubble level (i.e. if the actual RV length does not correspond to the calibrated scale of the F/B bubble level, the actual inclination height will differ from that indicated on the bubble level graduated scale).

Another issue with bubble type levels is that they must be installed while the RV is resting on a level surface. In addition, the level indicator must be affixed properly to the RV body. If the level indicator is not aligned properly during installation, an erroneous level reading will be indicated. No corrections can be made other than removing and re-installing the level indicator. Frequently, factory installed level indicators are not installed properly. In this situation, if the operator is aware of the problem he must make adjustments during the leveling operation to correct for the erroneous level reading.

The patent literature has proposed several solutions to the above problems with the commercially available products, but these proposed solutions do not adequately address all of the issues with the prior art commercial devices and as a practical aside they are not commercially available.

U.S. Pat. No. 4,658,508 entitled “Electronic Level Measuring Systems for Truck Trailers” discloses an electronic level measuring device for a tractor trailer in which a remote level sensing device is mounted on the rear frame of the trailer and a meter for indicating continuously the amount the trailer is tilted laterally is provided in the cab of the tractor. The meter also indicates the direction of tilt and changes scale when the tilt exceeds a predetermined amount.

U.S. Pat. No. 4,745,687 entitled “Level Indication Device and Method for providing a level indication of up to three degrees accuracy” discloses a level indicating device used to indicate proper orientation of a recreation vehicle (RV) such as a motor home, trailer, or camper. The device comprises of a generally transparent dome fixedly mounted on a base which can be removeably attached to a generally flat, horizontal surface which is preferably the ceiling of the RV. The dome is approximately half-filled with a liquid which is resistant to freezing, and carries a plurality of parallel lines graduated to indicate when the orientation of the base with respect to horizontal is within a three degree tolerance. In operation, the surface of the liquid lies generally between the plurality of parallel lines when the flat surface to which the base is attached is within three degrees of tolerance with respect to horizontal. The dome is illuminated by a conventional pen light removeably inserted into apertures in the base, the light being activated by pressing on one end of the light.

U.S. Pat. No. 4,760,649 shows a solid state electronic position indicating device which provides two indicators showing whether the vehicle is level or not through a pair of lights.

U.S. Pat. No. 4,972,596 entitled “Trailer Measuring System” discloses a device for leveling a trailer during setup and for indicating deviations from an initial position of level of a trailer in which the device includes a reservoir and a plurality of measuring tubes which can be secured to the frame of a trailer.

U.S. Pat. No. 5,136,784 entitled “Vehicle Electronic Level Measuring and Display Device” discloses a vehicle level and measuring and display device for use especially in recreational vehicles or the like for ensuring that the vehicle is in a gravitationally level position comprising a sensing unit remotely connected to a display unit. The display unit includes a plurality of incremental individual optical indicators disposed along a first line representative of the level position of the vehicle and a second line representing the level position of the vehicle whereby the individual LED optical elements can incrementally and individually display the particular level position of that line. The device includes at least two scales having both a rough and fine adjustment for the LED indicators.

U.S. Pat. No. 5,806,196 entitled “Method and Apparatus for aligning a towed vehicle with a towing vehicle” which teaches a bubble level based device.

U.S. Pat. No. 6,584,385 entitled “Vehicle Leveling Assembly” discloses a complex leveling assembly for analyzing the attitude of a structure such as a motor vehicle in two axes. The assembly drives leveling devices on the structure to correct the attitude of the structure relative to a calibrated reference point or attitude. The assembly includes a controller connected to the leveling devices and a proportional two-axis tilt sensor that is connected to the controller and supported on the structure. The tilt sensor provides analog signals to the controller that represent the attitude of the structure about longitudinal pitch and lateral roll axes. The controller also uses those signals to determine the attitude of the structure relative to a calibrated sensitivity factor and a user-defined zero point. This allows an operator or installer to determine which portion of the structure will be leveled without regard to the location of the tilt sensor and allows an installer to mount the tilt sensor at any point on the structure.

U.S. Pat. No. 6,885,924, similar to the '385 patent discloses a complex assembly for adjusting the attitude of any selected portion a structure such as a motor vehicle. A controller connects to and controls one or more jacks operable to change the attitude of a structure.

U.S. Pat. No. 7,025,361 relates to comprehensive vehicle leveling systems having the electronic controller which further include a plurality of jacks operably controlled by the electronic controller and a power system.

It is the objects of the present invention to address the deficiencies of the prior art.

### SUMMARY OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The various embodiments and examples of the present invention as presented herein are understood to be illustrative of the present invention and not restrictive thereof and are non-limiting with respect to the scope of the invention. According to one embodiment of the present invention addressing at least one of the above stated objects the present invention provides an affordable, two axis electronic level sensing and indication device that can be utilized to properly adjust the side-to-side (S/S) and front-to-back (F/B) inclination angles of a recreational vehicle, as referenced in FIG. 3, or other mobile platforms (such as festival vendor trailers, etc.), during arrival and departure setup operations.

In one non-limiting aspect of the present invention an electronic level indicating device for leveling at least one axis of a mobile platform comprises: at least one sensor configured to be coupled to a mobile platform, each sensor for detecting and signaling a measured inclination level of an axis of the mobile platform; a controller coupled to the at least one sensor; A display configured to be viewable by the user and coupled to the controller, the display including at least a level indicating visual indicator and a plurality of out of level visual indicators; and a level calibration mechanism configured to allow the user to set a preferred level position for the device, wherein the level indicating visual indicator is configured to indicate when the measured inclination level is about equal to the user set preferred level position and the out of level visual indicators are configured to indicate when the measured inclination level is about equal to the user set preferred level position. The term mobile platform will include RVs and other trailers and similar platforms.

The device described herein overcomes the limitations of the commercially available bubble type level and provides new features to RV owners that simplify leveling operations. The device provides an accurate, easy-to-use, low cost level indication system that can be easily installed on the exterior or interior of an RV. The device provides a visible and/or audible level indication that can be viewed from within the cab of the tow vehicle or motor home day or night. The device provides level indication along the 2 main RV axis's (S/S and F/B). The device can be calibrated at any time by the operator. Calibration can be performed on uneven terrain. The device can also store arrival inclination information for later recall during departure preparations.

The device described herein provides a leveling device that electronically determines inclination angles of the vehicle that it has been mounted to. In particular, the device can be utilized with Recreational Vehicles—RVs. The leveling device can be configured for OEM use or as an add-on accessory for existing RV units. The leveling device will provide inclination angle information for the S/S and F/B axis of the RV, as shown in FIG. 3. When power is applied, the inclination angle of each axis will be continuously measured, and converted to units of elevation that will be conveyed to the operator via indicator lights mounted on the front panel of the device. The units of elevation can be displayed in inches or centimeters. This system provides visual real-time feedback of the vehicle tilt angle which allows the operator to remain in the vehicle during RV leveling operations. Multiple indicator lights are arrayed in a pattern that correspond to the vehicle S/S and F/B inclination axis's (see FIG. 3A). The indicators will be arranged with a central green (or other unique color, size, or intensity) light and two or more inclination spokes (corresponding to each of the measured RV axis's) of red (or other unique color, size, or intensity) indicator lights (FIGS. 4 & 5). The RV is level when the central green indicator is illuminated and all red indicator lights are off. If not level, one or more red indicator lights will illuminate in an increasing fashion depending on how much the RV is tilted in each axis. Each inclination spoke of red indicator lights corresponds to a side of the RV (FIG. 3). Each red indicator light corresponds to a unit of elevation (inches or centimeters) of the associated axis. For each unit of elevation that the RV is out of tilt, a red indicator will be activated on the appropriate inclination spoke. For example, FIG. 4 indicates the RV is 3.5 inches high on the driver's side, and FIG. 5 indicates the RV is 2.5 inches high on the driver's side and 3 inches high in the front. The indicator lights on each inclination spoke may alternate in size, intensity, or color. For example, every other light on an inclination spoke may be orange, separated by lights that are red. This is done so that the operator can easily distinguish how many lights are illuminated.

The device may employ an audio transducer that will provide audible feedback corresponding to the degree of RV tilt (FIG. 3B). This feature will provide the user a secondary means of determining RV level status. Pressing the “Audio” push-button 48 on the display front panel will activate the audio feature for the S/S axis. Pressing the “Audio” push-button a second time will activate the audio feature for the F/B axis. A third press of the “Audio” push-button will disable audio operation. Repeated push-button activation's will toggle through the 3 audio states. When an axis is selected for audio operation, the elevation indicators for the corresponding axis may light in a defined pattern to acknowledge the selection.

The leveling device can have the capability to be re-calibrated at any time by the user. The system can be calibrated with the RV positioned on any surface. When the RV is leveled to the satisfaction of the user, activation of a “calibrate” push button will cause the system to store the current inclination information in non-volatile memory. This stored information will then be used as the “level” reference point for each axis of the vehicle. Subsequent operation of the device will utilize the stored reference points when calculating elevation information.

The leveling device may provide a “Storage/Recall” feature that the user can use to store the current inclination information for each axis in non-volatile memory. This feature will be useful during departure preparations of travel trailer type RV's, where the original F/B inclination angle of the trailer must be restored in order to match the tow vehicle hitch system. Activation of the “Recall” push button will provide the user an indication of when the trailer elevation corresponds to the originally stored value. This may be indicated by flashing a light on the appropriate inclination spoke, corresponding to the original inclination angle. The user can raise or lower the trailer jack until the device indicates the original elevation has been achieved.

These and other advantages of the present invention will be clarified in the description of the preferred embodiments taken together with the attached figures.

### BRIEF DESCRIPTION OF THE DRAWINGS

FIG. 1 is a schematic side view of the conventional RV types associated with the present invention;

FIG. 2 is a side view of a conventional, commercially available bubble type level of the prior art;

FIG. 3A is a schematic representation of the problem addressed by the present invention;

FIG. 3B is a schematic representation of the tone rate at various illustrated RV tilt angles;

FIG. 4 is a plan view of the electronic level indicator according to one aspect of the present invention;

FIG. 5A is a plan view of an alternative electronic level indicator according to another aspect of the present invention;

FIG. 5B is a plan view of an alternative electronic level indicator according to another aspect of the present invention;

FIGS. 6-13 are plan views of alternative electronic level indicators according to further embodiments of the present invention;

FIG. 14 is a block diagram of the circuitry for the electronic level indicator according to the present invention;

FIG. 15 is a block diagram of the sensor signal circuitry for the electronic level indicator according to the present invention; and

FIG. 16 schematically illustrates distinct sensor/mounting surface inclinations.

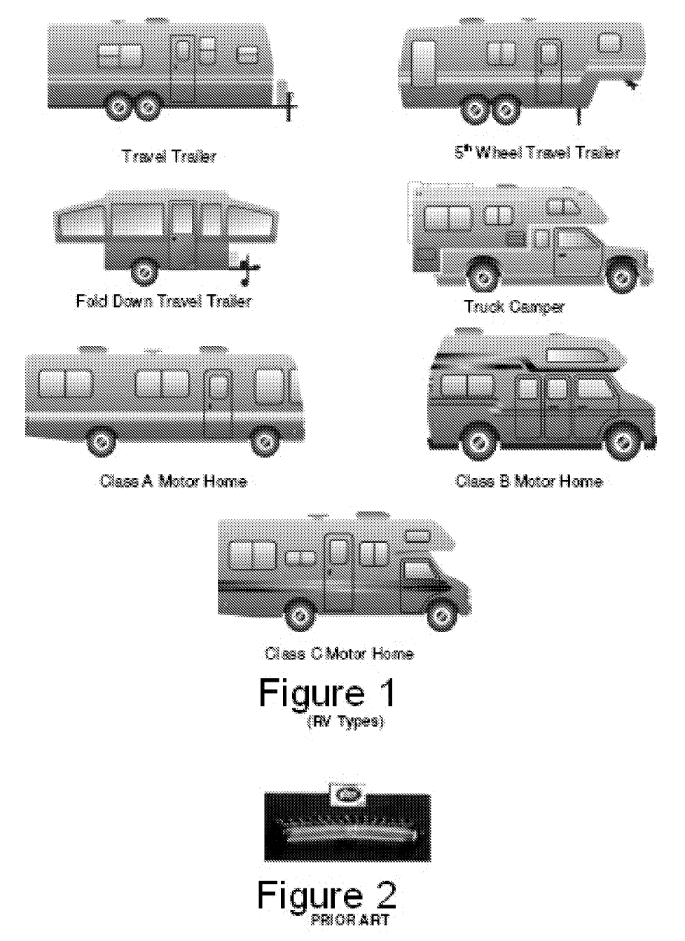

### DESCRIPTION OF THE PREFERRED EMBODIMENTS

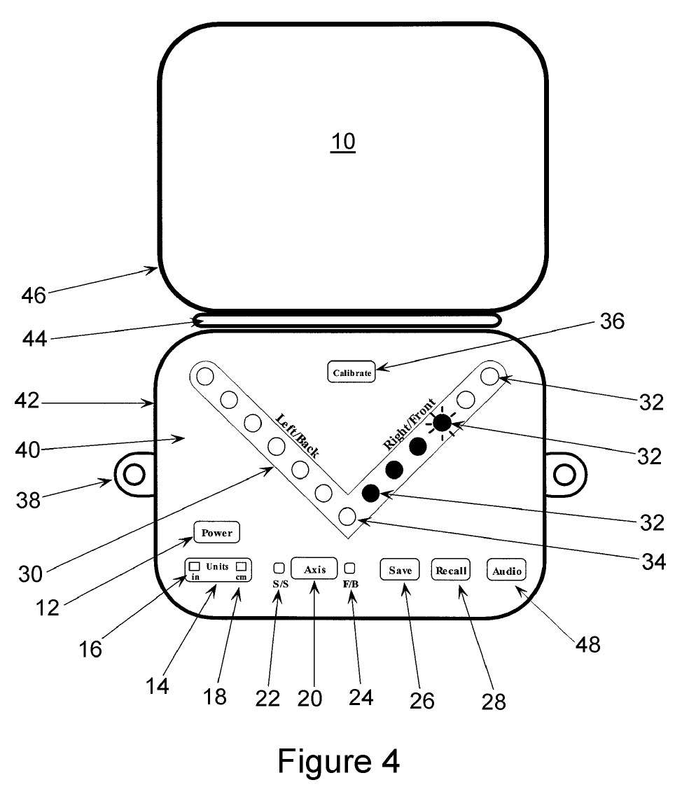

The electronic level indicator or device 10 according to a first embodiment of the present invention is illustrated in FIG. 4, the reference numerals of which are explained in the following.

A Power Push Button 12 activates and deactivates the device when pressed. Further, the device 10 automatically deactivates after a defined period of inactivity.

A Units Push Button 14 enables selection or toggling between displayed units of elevation on the Inclination Display 30, discussed further below, between inches and centimeters. An Inch Units Indicator Light 16 will, when activated, indicates the device displays elevation information in inches and a Centimeter Units Indicator Light 18, when activated, indicates the device displays elevation information in centimeters. The elevation amount is a measured linear distance at a given point along the axis, such as the wheels in a side to side axis and the bumpers (or jack locations) for the front to back axis.

An Axis Push Button 20 toggles the device function between displaying the S/S or F/B inclination information on the Inclination Display 30. An S/S Axis Indicator Light 22 indicates, when activated, that the S/S inclination is currently displayed on Inclination Display 30. An F/B Axis Indicator Light 24 indicates that the F/B inclination is currently displayed on Inclination Display 30.

Another critical aspect of the invention for allowing previous positions to be recalled involves the Save Push Button 26. When the push button 26 is activated, the current F/B elevation information is stored in non-volatile memory. When used in conjunction with the Recall push button 28, stored elevation information can be redisplayed on the Inclination Display 30. This feature is useful in adjusting the vehicle elevation to a previous height. As suggested, when the Recall Push Button 28 is activated previously stored elevation information is displayed on the Inclination Display 30. The information will be displayed in a manner that will aid the operator in adjusting the vehicle elevation to the previous elevation. This may entail flashing the indicator lights until the current elevation matches the stored elevation. Alternatively the stored position may flash and the actual position shown in a non-flashing manner (or vice versa) and when the desired position is reached the two displays would “overlap” and the flashing indication would cease.

The Inclination Display 30 is an array of indicator lights arranged in a spoke fashion, such as the “V” shape depicted in FIG. 4. Each spoke will be comprised of several Elevation Indicator lights 32. Each spoke will converge at a single Level Indicator light 34. Each spoke will be used to display elevation information of a specific orientation of the RV depending which axis has been selected via the Axis Push Button 20. For example, if the S/S axis is selected (and shown at light 22), the left spoke of Inclination Display 30 will correspond to the left side of the RV. The right spoke will correspond to the right side of the RV. If the F/B axis is selected as shown at light 24, the left spoke of Inclination Display 30 will correspond to the back of the RV. The right spoke will correspond to the front of the RV.

Other configurations of the Inclination Display 30 are possible, such as a “+” layout where both vehicle axis's are displayed simultaneously. In addition, other types of indicators may be employed, such as an alphanumeric display in a LCD indicator.

The single Level Indicator Light 34 is assigned to indicate a “level” position. When this indicator light 34 is activated and all other Inclination Display 30 lights 32 are deactivated (except in recall mode), the RV will be considered leveled to the orientation of the stored calibration setting set through calibration button 36. In short, when leveling in any axis the calibration button 36, when activated, will set the current position as the desired level position for that axis. This position may or may not actually be horizontal, but is variable for user preference (e.g. some may wish to slightly elevate the head of the beds in a trailer). Because of the “Calibration” feature of the device 10, the level indication may indicate “true” to the earth's surface, or to the orientation stored by the operator during the calibration process.

Each activated Elevation Indicator light 32 will correspond to one unit of elevation (i.e. 1 inch). Depending on the particular tilt (relative to the “level” position in that axis, of the RV, one or more Elevation Indicator lights 32 will be activated in an ascending fashion. For example, 3 active Elevation Indicator lights 32 along one spoke will indicate that the RV is high 3 inches in that direction from the level position. In one aspect of the invention, the device 10 may indicate elevations that are in between 2 units by flashing one appropriate Elevation Indicator lights. Further, deactivated Elevation Indicator lights will indicate that RV elevation is less than the associated deactivated light.

As discussed above activation of the push button 36 for a defined interval will cause the current elevation information for at least the current axes, and possibly both axes, of the RV to be stored in non-volatile memory. At the completion of the calibration sequence, the device 10 will activate the Level Indicator light 34 and deactivate all Elevation Indicator lights 32. The device 10 will reference the stored calibration information during all subsequent level indicating operations.

A Device Enclosure Mounting Tab 38 facilitates mounting of the device 10 to the RV. This may entail screw mounting, double sided adhesive tape, mounting brackets or other means. A Front Panel 40 may consist of an overlay that will either cover the underlying device indicator lights and push buttons, or these components may be integral to into the overlay panel. The front panel 40 will be resistant to moisture and sun light.

The Device Enclosure 42 will house the system electronics and provide mounting brackets and will be resistant to moisture and sun light. A Protective Cover Hinge 44 may be provided to incorporate a moveable protective cover plate 46. Other configurations may entail a removable cover plate fastened to the enclosure 42.

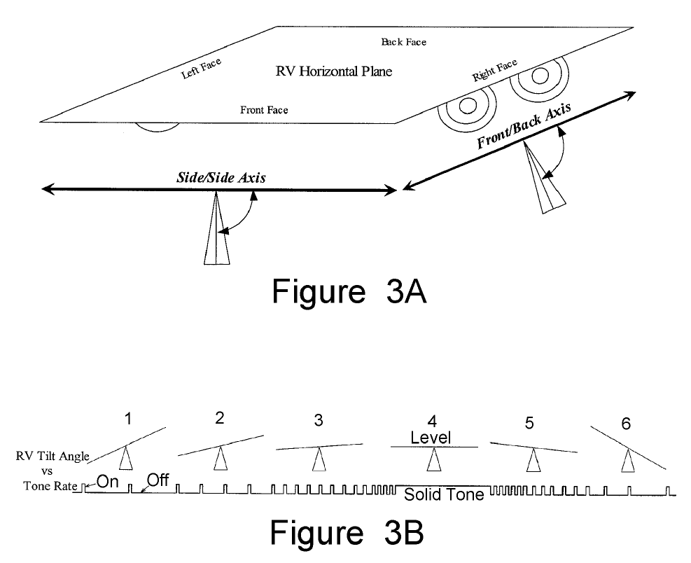

The device 10 includes an Audio Enable Push Button 48 that will activate the audible feedback feature. When activated, the device 10 will emit audio tones of varying frequency or duty cycle corresponding to the RV tilt angle as represented in FIG. 3B. Each press of the Audio push-button 48 will toggle through the available axis selections. At power up, the device 10 will disable audio operation. Pressing the “Audio” push-button 48 the first time will activate the audio feature for the S/S axis. Pressing the “Audio” push-button a second time will activate the audio feature for the F/B axis. A third press of the “Audio” push-button will disable audio operation. Repeated push-button activations will toggle through these 3 operating states. When an axis is selected for audio operation, the elevation indicators for the corresponding axis may light in a defined pattern to acknowledge the selection. Another option is to automatically select the audio feature corresponding to the already selected S/S or F/B axis.

When the RV is level in the selected axis, a solid tone will be emitted. As the tilt angle moves away from level, the frequency or duty cycle of the emitted tone will change i.e. lower frequency or duty cycle. This varying audio tone will provide the user with non-visual RV tilt information.

When a stable level condition is detected, the audio operation may turn off after a defined interval. Subsequent movement of the tilt angle may reactivate audio operation for the selected axis.

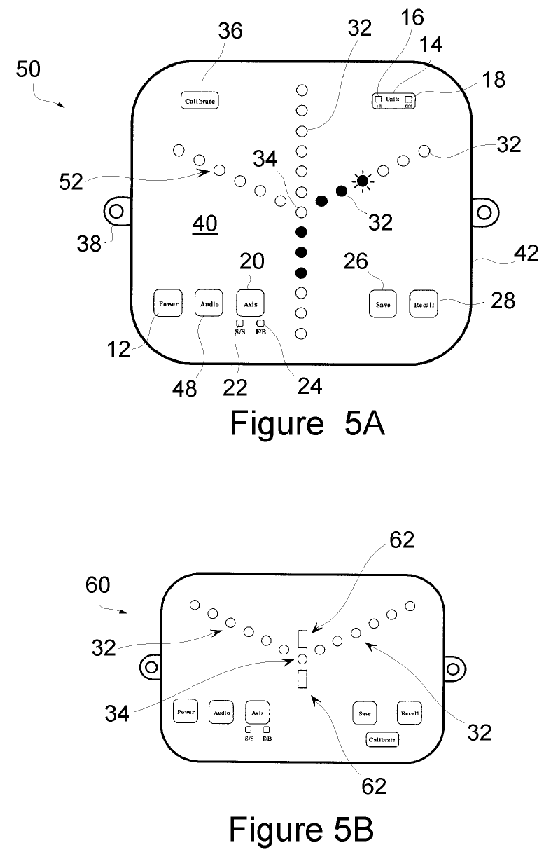

The device front panel may be configured to display a single axis (at a time) as shown in FIG. 4, or the system can be configured to display 2 axis's simultaneously as shown in FIG. 5A. The electronic level indicator 50 according to a second embodiment of the present invention is illustrated in FIG. 5A. FIG. 5A depicts an alternative layout of the inclination display indicators 52. In this configuration, both the S/S and F/B axis can be displayed simultaneously, or individually. The axis button 20 will now cycle through the display of the S/S axis only, the F/B axis only or both axis simultaneously, which will be displayed appropriately by lights 22 and 24. The functionally of the device push buttons 12, 48, 26, 28, 36 and 14 are the same as described for FIG. 4. In this embodiment the left spoke of lights 32 are utilized to indicate the elevation of left side of the RV in the S/S axis only and the right spoke of lights 32 are utilized to indicate the elevation of right side of the RV in the S/S axis only. Further, the lower spoke of lights 32 are utilized to indicate the elevation of front end of the RV in the F/B/ axis only and the upper spoke of lights 32 are utilized to indicate the elevation of back end of the RV.

This section describes an alternate dual axis display panel or device 60 shown in FIG. 5B. For clarity the reference numerals of elements that remain unchanged have largely been removed for clarity. The intent of this configuration is to reduce manufacturing costs and simplify indicator interpretation for the user. This configuration is targeted for the tow-able trailer market. Leveling operations of tow-able travel trailers differ slightly from that of a motor home. Motor home RV's (unless equipped with hydraulic leveling jacks), must be positioned in a single operation, i.e. S/S and F/B must be leveled together. For the motor home user, knowledge of F/B elevation units as well as the S/S elevation units are necessary when selecting and positioning leveling blocks. Whereas, the tow-able RV is normally leveled in a two part sequence: first the S/S is leveled while connected to the tow vehicle, then the tow vehicle is unhitched and the F/B is leveled using front leveling jack. Tow-able RV users are typically interested only in achieving a F/B level condition. As leveling blocks are not used when adjusting the F/B axis of tow-able RV's, precise knowledge of the initial elevation value is not needed. For this reason, Motor home users will find the F/B indicator light array 62 more useful than tow-able users.

Another issue associated with indicating F/B elevation, is variations in RV lengths effect accuracy. For maximum accuracy, the length of the RV must be programmed into the device 10, 50 or 60. This requires additional device features and increased user involvement. In an effort to reduce manufacturing costs, simplify user involvement, and reduce the front panel display complexity, the design shown in FIG. 5B was developed. The following is a description of the alternate aspects of the dual axis display panel 60 of FIG. 5B. The functionally of the device push buttons are the same as described for FIG. 4. The left spoke of lights 32 are utilized to indicate the elevation of left side of the RV, the Level Indicator 34 is activated to indicate the selected axis is level and the right spoke of lights 34 are utilized to indicate the elevation of right side of the RV all similar to device 50. Further, lower light of array 62 indicates the front of the RV is high and the upper light of array 62 indicates the back of the RV is high.

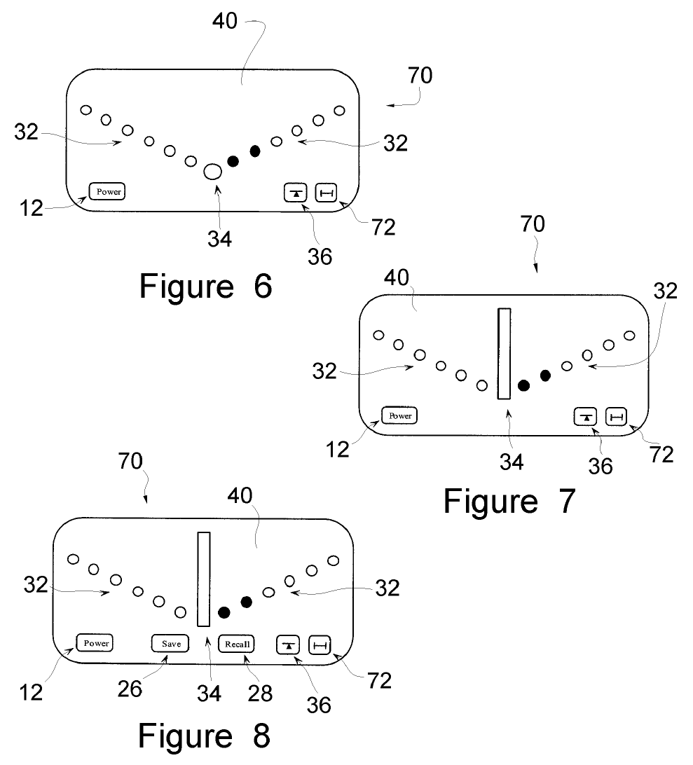

The system may also be configured to monitor and display only a single axis represented as device 70 in FIGS. 6-13. This system can be configured with a single axis inclination sensor and a corresponding simplified display panel. This configuration may offer a lower cost device due to lower component count, sensor and display panel cost savings. Examples of the display panels 40 associated with the single axis device 70 are shown in FIGS. 6, 7, 8, 9, 10, 11, 12, and 13.

The single axis system of device 70 can be utilized to measure either of the vehicle's 2 main axes—F/B or S/S (see FIG. 3A). This device 70 can be affixed to any exterior or interior surface (for motor home applications) of the RV (FIG. 3A). Because the length of the measured axis affects the accuracy of the system, a method of user calibration will be provided. The system of device 70 will allow the user to program the length of the desired vehicle axis via display panel push buttons. The system will default to a length of 8 feet, which is the side to side width of a standard RV. Once the desired vehicle length has been set, all elevation measurements will reference this length value during elevation calculations.

FIGS. 6 and 7 depict variations of the single axis display panel 40 and are described further below. The power push button 12 will control the activation/deactivation of the system or device 70 and the system may incorporate an automatic inactivity power down feature.

As described above, the device 70 can be mounted on any of the four RV faces (internal or external) in order to measure the desired axis. The Left Elevation Display Wing is the array of lights 32 on the left side of the level indicating light 34 and corresponds to side of the RV that is directly to the left of the operator, when the operator is facing the device display panel 40. Depending on the installation location, this may correspond to the back or front face of the RV or the left or right side or the RV. For example, if the device 70 is mounted on the right exterior face (FIG. 3) in order to measure the F/B elevation, the Left Elevation Display Wing will indicate the front elevation. The device 70 could also be mounted the left exterior face (FIG. 3) in order to measure the F/B elevation. In this case the Left Elevation Display Wing would correspond to the back elevation. The same is true of placement of the device on the front face or back face when measuring S/S elevation.

In an analogous manner to the left elevation display wing, the Right Elevation Display Wing is the array of lights 32 on the right side of the level indicating light 34 and corresponds to side of the RV that is directly to the right of the operator, when the operator is facing the device display panel 40.

The device 70 includes an RV length setting feature for the measured axis which includes a length setting activation button 72. Activation of this push button 72 will allow the user to program the length of the RV axis that is to be measured. In most cases, this feature is only utilized if the device is used to measure the F/B RV axis. This programmable feature facilitates measurement accuracy over the range of RV lengths. This feature may also be implemented using other device push button activation's or combination of push button activation's, thus eliminating the need for a specialized push button 72. For example, defined Power push button activations may cause the system to enter into the length programming mode. Further once in the length setting mode the lights 32 and 34 and other push buttons may be incorporated to assist the user in inputting changes in the default axis length.

In a manner similar to the above described devices, the device 70 includes a calibration system using button 36, wherein activation of this push button 36 will cause the current elevation information for axis of the RV to be stored in non-volatile memory. The device 70 will activate the Level Indicator light 34 and deactivate all elevation indicator lights. The device 70 will reference this level measurement during all subsequent level indicating operations.

The indicator light 34, as noted above, is used to indicate the measured axis is level. FIG. 6 incorporates a round indicator light 34 and FIG. 7 incorporates a bar shaped indicator light 34.

FIG. 8 depicts a variation of the single axis system of device 70. This system or device 70 incorporates the Save/Recall feature using buttons 26 and 28, described above. This feature may be desirable when the device 70 is used on the front to back axis of the RV.

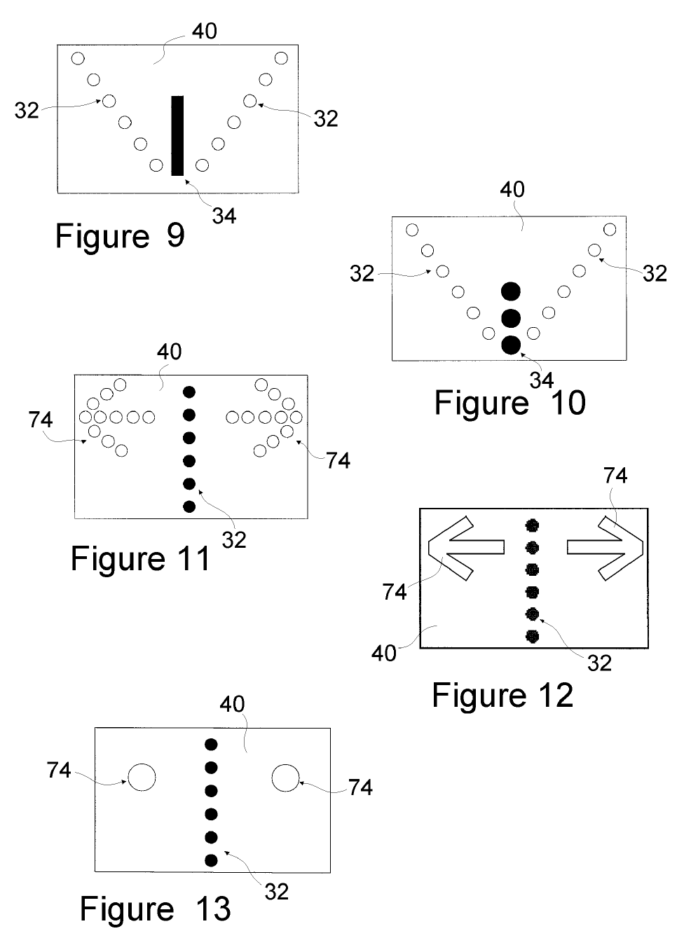

FIGS. 9 through 13 depict additional variations in the layout of the front panel elevation/level indicator lights 32 and 34 on the front panel 40. FIGS. 9 and 10 utilize a unique color for each elevation wing of lights 32. The level indicator light 34 in FIG. 9 incorporates a solid light bar, where discrete indicator lights 34 are utilized in the layout in FIG. 10.

The layouts in depicted in FIGS. 11, 12, and 13 departs from the “dual elevation wing” concept. In these layout configurations, units of elevation are indicated by the center line of indicator lights 32. Each light 32 will indicate one unit of elevation (i.e. one inch), with the bottom light equating to one unit, and the top light equating to 6 units. In this configuration, the location that the elevation corresponds to (i.e. front, back, right, left), is indicated by the icon lights 74 to the left and right of the elevation indicator lights 32. Example: the device 70 is mounted on the front face of the RV in order to measure S/S elevation. If the RV is tilted high on the right side, the “right side” indicator 74 will illuminate informing the user that the associated elevation indicators 32 correspond to the right side of the RV. If the RV is tilted high on the left side, the “left side” indicator lights 74 will illuminate informing the user that the associated elevation indicator lights 32 correspond to the left side of the RV. If the RV is tilted beyond the range of the measurement capabilities of the device 70, all of the elevation indicator lights 74 will be flashed. With this display configuration, a level condition may be indicated in several ways: all elevation lights (item 1) turned off, the right and left direction icons flash. Another way of indicating level would be lighting all of the elevation indicator lights and changing their color. This can be accomplished by using bicolor indicator lights.

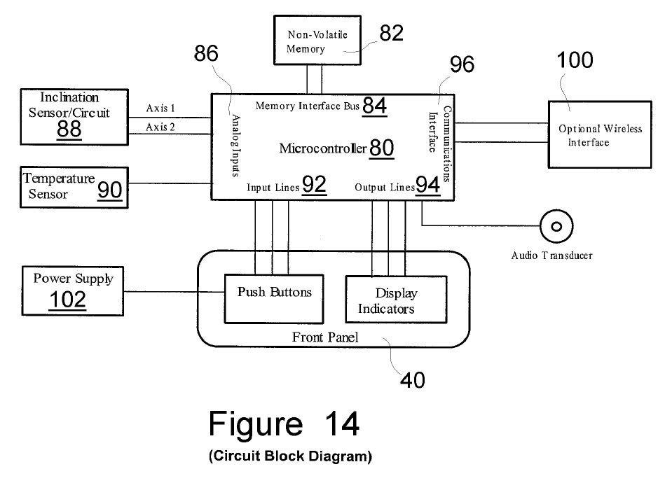

The level indicating devices 40, 50, 60, and 70 contains electronic circuitry that will be capable of detecting degrees of inclination relative to the earth's surface. The devices 40, 50, 60, and 70 will consist of the following components shown schematically in FIG. 14 (see FIG. 14 for schematic drawing). A Microcontroller 80, or similar microprocessor device, controls the overall operation of the leveling system. The software (firmware) program for this application is stored in non-volatile memory 82 that may reside internal or external to the microcontroller 80. External non-volatile memory 82, if used, will interface to the microcontroller 80 via an address/data bus or a communication port 84. Non-volatile memory will also be provided various system parameters that may be altered during the operation of the device, such as calibration parameters.

The microcontroller 80 may contain one or more analog inputs 86, that can be connected to external sensors such as inclination sensors 88 and temperature sensors 90. The microcontroller 80 will provide one or more digital input ports 92 that can be utilized to monitor the state of the user push button switches (such as 12, 48, 20, etc.). The microcontroller 80 will provide one or more digital output ports 94 that can be utilized to control the activation of the display indicator lights (such as 32, 34 and 74) and audio output. The microcontroller may provide a communications port 96 that can be utilized to communicate with optional external devices, such as a wireless transceiver module, which as described below may allow for remote placement of the display 40 whereby the input and output would be through the interface 96.

The system of the invention will incorporate one or more sensors 88 that provide inclination information that can be accessed by the microcontroller 80. Each sensor 88 will be positioned within the device such that a defined vehicle axis can be monitored. Additional signal conditioning circuitry may be provided to adjust for sensor mounting angle variations and vehicle length variations. The sensors 88 will provide an analog or digital output that is proportional to the devices orientation to the earth's surface. The sensor 88 may consist of a specialized integrated circuit, or other electromechanical device such as a variable resistance or magnetically coupled position sensor.

The system may incorporate a sensor 90 that can provide temperature information to the microcontroller 80. Depending on the type of inclination sensor 88 utilized in the device, system measurement accuracy may be improved by correcting for changes in ambient temperature.

As noted above, non-volatile memory 82 will be included for the storage of system firmware and other system variables. This may include read-only (ROM) memory, and or read-write non-volatile memory such as Flash or Electrically Erasable memory or on-chip microprocessor memory.

A Power Supply 102 is provided and may be in several conventional formats. The system can be configured to operate from the RV AC or DC power source. The system can also be configured to operate from replaceable batteries.

As described above the front panel 40 of the device will contain several push buttons that will be assigned to specific functions. The push buttons may be assessable to the user when the front panel protective cover is removed. The system microcontroller 80 will monitor the push buttons for activation.

As described above the front panel 40 of the device will contain an array of indicator lights such as light emitting diodes (LED), that the system will activate in response to elevation changes. The system may also incorporate indicator lights to highlight various operating modes and status. For example, the unit may contain circuitry that detects a low battery condition and may incorporate visual and/or audio indicators to alert the user to a low battery condition.

The system may be configured to interface to a wireless transceiver module 100. The wireless transceiver module 100 can be utilized with other remote sensors or a remote display unit that may be located in a tow vehicle cab or may be a hand-held battery operated device.

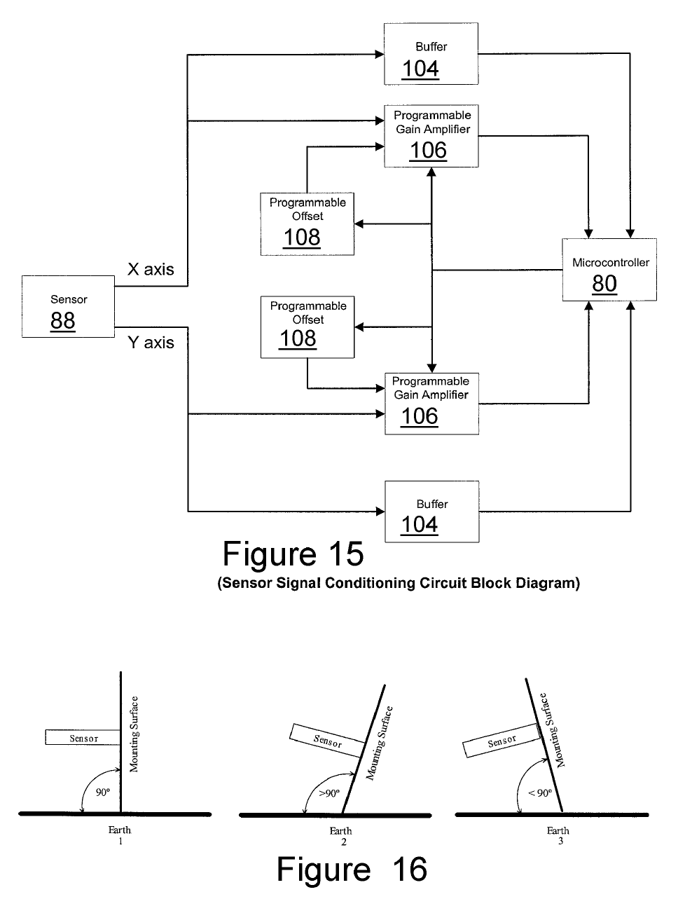

FIG. 15 is a block diagram of the sensor signal circuitry for the electronic level indicator according to the present invention. The raw x and y axis output signals of the angle sensor 88 are amplified (buffers 104) and monitored by the microcontroller 80. Additional amplifiers 106 provide programmable gain along with programmable offset voltages 108 that are utilized to correct for sensor mounting angle variations and vehicle length variations. These amplifiers 104 and 106 can incorporate programmable or fixed gain circuitry.

The output of the sensor 88 is typically ½ the sensor's supply voltage when the sensor 88 is mounted in a plane that is parallel to the earth's surface (FIG. 16 item 1). The sensor output changes as the device angle changes relative to the earth's surface (FIG. 16, item 2, 3). The raw sensor output is amplified so that the A/D converter can resolve small angle changes. In normal use, it is possible that the device will be mounted to a surface such that the sensor inside the device is no longer parallel to the earth's surface (FIG. 16 item 2, 3) and the amplifiers output will change accordingly. If the sensor is mounted at an angle (FIG. 16 item 2, 3), the sensor's voltage output changes to a value indicative of the mounting angle. Mounting angle deviations can reduce the sensitivity of the sensor signal interpretation because amplification of the raw sensor output could saturate the amplifier thereby rendering the amplified signal useless, i.e. the amplified output voltage would not change as the sensor angle changes. To overcome this problem, a programmable offset section has been introduced for each axis and is controlled by the microcontroller 80. This feature will enable the microcontroller 80 to adjust the programmable offset and gain associated with each axis sensor 88 to operate within an optimal range.

A low pass digital filter algorithm is executed by the microcontroller to filter out any vibration induced transients (signal spikes), which are sudden short duration, low duty cycle changes in the sensor output. These transients can occur as the vehicle is moving.

The gain of the x and y axis amplifiers 104 and 106 can be changed so that different delta voltage per delta angle changes can be programmed. The amplifier gain can be set to a constant value or can be made programmable which is controlled by the microcontroller 80.

The following sequence is performed in order to calibrate the device to allow for varying mounting angles: (1) Mount the device to the vehicle; (2) Press the “Set Level” button; (3) The microcontroller 80 obtains the raw sensor output voltage on both axes; (4) The microcontroller 80 adjusts the offset control on each axis amplifier so that the amplified sensor output matches the raw sensor output; (5) the microcontroller 80 stores the amplified sensor output and raw sensor output; (6) the microcontroller activates the “level” LED; (7) The microcontroller monitors the amplified sensor output and compares this to the previously stored amplified sensor output. The microcontroller continuously computes the delta change in voltage and converts this to an angle or delta height change and activates the corresponding LED's.

By incorporating a programmable gain amplifier, the device can be calibrated to display various angles or inclination heights versus length. For instance, the LED's can be programmed to illuminate at 1 inch delta height intervals (or degrees of angle) based on an 8 foot length. By changing the gain of the amplifier, the LED's can be programmed to illuminate at 1 inch delta height intervals based on a 16 foot length or any desired length (or any degree of angle).

The amplifier has a respective programmable offset which allows the angle or height of inclination to be resolved if the device is mounted at an angle not parallel to the earth's surface. This is a unique and helpful concept because it allows for manufacturing tolerances when mounting the sensor in the enclosure and compensates for mounting/alignment errors when the user installs it on a vehicle.

The amplifier has a programmable gain which allows for different inclination displays based on the horizontal length over which the angle/inclination is displayed. This is a helpful concept because other levels on the market (like electronic levels) only display the angle over the length of the 3 or 4 foot level.

As discussed above the device can be configured to incorporate wireless technology (RF data transmitter and receiver). This system is comprised of a Display Unit that indicates user vehicle tilt information and one or more remote tilt sensors that are positioned on or in the RV. With this system, the Display Unit can be installed in the tow vehicle or motor home driver compartment. The Display Unit may also be configured for portable operation, allowing the operator the freedom to position the device in any desired location. The Display Unit and the remote sensor may contain circuitry that detects a low battery condition and may incorporate visual and/or audio indicators to alert the user to a low battery condition. The Display Unit and sensor will have circuitry/software to test the integrity and strength of the wireless transmission signal. This ensures that the Display Unit is receiving a suitable signal from the remote sensor(s). A visual or audio alarm may be used to indicate that the wireless link has been lost or degraded. This system provides features similar to the device configurations previously described in this document. The main difference is that the tilt sensor is disassociated from the user interface device. This provides several benefits. First, the Display Unit can be conveniently located in the tow vehicle or motor home driver compartment. This provides the user a more optimum viewing capability. Second, the tilt sensor can be installed anywhere within the RV. For example, the sensor can be installed in a storage compartment or in a kitchen cabinet. This feature enables the user to position the sensor in an inconspicuous location. Third, installing the sensor within the RV and having the Display Unit located in the driver's compartment reduces manufacturing costs associated with harsh environment overlays and enclosures.

The display panel layouts currently illustrated are limited to the leveling device of the present invention. However it is anticipated that the panel may be an integrated display board or platform for incorporating a number of RV management components other than the leveling device described herein. Additional display elements and control inputs would be selectively added for each additional system. The additional RV control systems may include an RV back-up positioning device, such as sold under the brand RV STOP by the assignees of the instant invention. Further RV control systems to display on the common display would be for the operation and status of backup lights and brake lights; a system identifying the activation of and internal temperature of an RV based refrigerator; a system identifying whether a door or window has come open on the RV; a tire pressure indication system. The control panel for such an integrated system may have a series of display lights and inputs associated with each individual system, or may use a common display (e.g. a computer screen).

Whereas a particular embodiment of this invention has been described above for purposes of illustration, it will be evident to those skilled in the art that numerous variations of the details of the present invention may be made without departing from the invention as defined in the appended claims. The scope of the present invention is intended to be defined by the appended claims and equivalents thereto.

What is claimed is:

1. An electronic level indicating device for leveling at least one axis of a mobile platform comprising:
At least one sensor configured to be coupled to a mobile platform, each sensor for detecting and signaling a measured inclination level of an axis of the mobile platform;
A controller coupled to the at least one sensor;
A display configured to be viewable by the user and coupled to the controller, the display including at least a level indicating visual indicator and a plurality of out of level visual indicators; and
A level calibration mechanism configured to allow the user to set a preferred level position for the device, wherein the level indicating visual indicator is configured to indicate when the measured inclination level is about equal to the user set preferred level position and the out of level visual indicators are configured to indicate when the measured inclination level is not about equal to the user set preferred level position.

2. The electronic level indicating device according to claim 1 further including a level storage mechanism that will store a current measured inclination level of the axis of the mobile platform; and a stored level recall mechanism that will recall a stored measured inclination level and will visually display the stored measured inclination level to the user using at least one of the level indicating visual indicator and the plurality of out of level visual indicators, wherein the stored measured inclination level is displayed when recalled along with a current measured inclination level.

3. The electronic level indicating device according to claim 1 further including a unit measurement indicator visually identifying the unit measurements of the out of level visual indicators, and wherein the plurality of out of level visual indicators form an array of out of level visual indicators wherein each sequential out of level visual indicator is associated with a fixed unit measurement that is visually identified.

4. The electronic level indicating device according to claim 1 wherein the microprocessor provides for an adjustable gain on the sensor signal of the measured inclination level of an axis of the mobile platform.

5. The electronic level indicating device according to claim 4 wherein the adjustable gain is configured to accommodate a specific length of the platform along the associated axis, whereby the device is configured to accommodate distinct specific lengths.

6. The electronic level indicating device according to claim 1 wherein the microprocessor provides for an adjustable offset on the sensor signal of the measured inclination level of an axis of the mobile platform.

7. The electronic level indicating device according to claim 1 wherein the device is configured to measure both a side to side axis of the platform and a front to back axis of the platform.

8. The electronic level indicating device according to claim 7 further including a user selection input to selectively display measured inclinations in one of either the side to side axis and the front to back axis.

9. The electronic level indicating device according to claim 7 wherein the plurality of out of level indicators are configured to simultaneously display measured inclinations in both the side to side axis and the front to back axis.

10. The electronic level indicating device according to claim 1 further including an audio mechanism coupled to the controller wherein the audio supplied to the user is indicative of the measured inclination.

11. The electronic level indicating device according to claim 1 further including a user selection input to selectively display measured inclinations in one of either inches and centimeters and further including an automatic powering down of the device after a defined interval at the desired level condition.

12. An electronic level indicating device for leveling at least one axis of a mobile platform comprising:
At least one sensor configured to be coupled to a mobile platform, each sensor for detecting and signaling a measured inclination level of an axis of the mobile platform;
A controller coupled to the at least one sensor;
A display configured to be viewable by the user and coupled to the controller, the display including at least one level indicating visual indicator and a plurality of out of level visual indicators;
A level storage mechanism that will store a current measured inclination level of the axis of the mobile platform; and
A stored level recall mechanism that will recall a stored measured inclination level and will visually display the stored measured inclination level to the user using at least one of the level indicating visual indicator and the plurality of out of level visual indicators, wherein the stored measured inclination level is displayed when recalled along with a current measured inclination level.

13. The electronic level indicating device according to claim 12 further including a wireless transceiver module wherein the display is configured to be remote from the sensors.

14. The electronic level indicating device according to claim 12 further including a level calibration mechanism configured to allow the user to set a preferred level position for the device, wherein the level indicating visual indicator is configured to indicate when the measured inclination level is about equal to the user set preferred level position and the out of level visual indicators are configured to indicate when the measured inclination level is about equal to the user set preferred level position.

15. The electronic level indicating device according to claim 12 wherein the microprocessor provides for an adjustable gain on the sensor signal of the measured inclination level of an axis of the mobile platform.

16. The electronic level indicating device according to claim 15 wherein the adjustable gain is configured to accommodate a specific length of the platform along the associated axis, whereby the device is configured to accommodate distinct specific lengths.

17. The electronic level indicating device according to claim 12 further including a unit measurement indicator visually identifying the unit measurements of the out of level visual indicators, and wherein the plurality of out of level visual indicators form an array of out of level visual indicators wherein each sequential out of level visual indicator is associated with a fixed unit measurement that is visually identified.

18. An electronic level indicating device for leveling at least one axis of a mobile platform comprising:
At least one sensor configured to be coupled to a mobile platform, each sensor for detecting and signaling a measured inclination level of an axis of the mobile platform;
A controller coupled to the at least one sensor;
A display configured to be viewable by the user and coupled to the controller, the display including at least one level indicating visual indicator, a plurality of out of level visual indicators forming an array of out of level visual indicators, and a unit measurement indicator visually identifying the unit measurements of the out of level visual indicators, and wherein each sequential out of level visual indicator is associated with a fixed unit measurement that is visually identified.

19. The electronic level indicating device according to claim 18 wherein the microprocessor provides for an adjustable gain on the sensor signal of the measured inclination level of an axis of the mobile platform.

20. The electronic level indicating device according to claim 18 wherein the adjustable gain is configured to accommodate a specific length of the platform along the associated axis, whereby the device is configured to accommodate distinct specific lengths.
